(19) United States
(12) Patent Application Publication
(10) Pub. No.: US 2006/0082533 A1
(43) Pub. Date: Apr. 20, 2006

(54) Pixel equivalent circuit and method for improving hold-type effect

(75) Inventors: Liou Chang-Ho, Shetou Shiang (TW); Chang Bou-Chi, Hsinchu City (TW); Huang Hsin-Mao, Alian Shiang (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 11/052,827

(22) Filed: Feb. 9, 2005

(30) Foreign Application Priority Data
Oct. 19, 2004 (TW) 93131610

(51) Int. Cl. G09G 3/36

(52) U.S. Cl. 345/92

(57) ABSTRACT

A pixel equivalent circuit and a method for improving a hold-type effect are disclosed. The present invention provides a capacitor having a plurality of pixel charging paths for a pixel equivalent circuit and supplies a target image voltage and such as a black image voltage or a compensating voltage to the capacitor during a corresponding duty cycle. Therefore, a color curve, which is shown by a corresponding pixel of the pixel equivalent circuit of the present invention, is similar to that of the CRT monitor or the speed of renewing data of the target image voltage is raised such that the pixel equivalent circuit of the present invention is capable of improving the color-renewing speed and image quality while processing moving images.

### 1. FIELD OF THE INVENTION

The present invention relates to a pixel equivalent circuit and a method for improving a hold-type effect. In particular, the present invention relates to a pixel equivalent circuit capable of providing a plurality of pixel charging paths for enabling the pixels of a LCD to have better dynamic contrast in color (brightness and chrominance) transformation.

### 2. BACKGROUND OF THE INVENTION

In comparison with a cathode ray tube (CRT) monitor, a liquid crystal display (LCD) is characterized by light weight, small volume, and low radiation. Following the maturity of LCD technology, current LCD not only has significantly improved viewing angle, but also enjoys a comparatively low price caused by cost down the manufacturing of LCD panel. In this regard, LCD display is progressively replacing the conventional CRT monitor.

Although the processing speed (so-called response time) of the LCD monitor for processing moving image has reached to a certain level, the response time of LCD monitor is still not as fast as that of the CRT monitor.

Please refer to FIG. 1A and FIG. 1B, which show relationship diagrams between intensity and time of a CRT monitor and a LCD monitor respectively. As shown in FIG. 1A, the CRT monitor is an impulse-type display, that is, an image is produced by the irradiation of a single electron beam onto fluorescent-coated pixels which emit light. The pixels emit light only for one instant within each frame, so there is almost no visual overlap between images. In this regard, every pixel of the CRT monitor has preferred dynamic brightness contrast, such that the dynamic contrast of intensity transformation and chrominance transformation in a pixel of CRT monitor is obvious while processing moving images. Therefore, each frame of the moving images has obvious dynamic color contrast, and consequently, the CRT monitor is capable of providing good moving image quality.

On the other hand, as seen in FIG. 1B, the LCD monitor is a hold-type display, that is, each time the image changes, the brightness also changes in a step-by-step sequence so that this type of continuous display causes a viewer to see the old image overlapping the new one resulting in a blurring of image profile. In this regard, every pixel of the LCD monitor has undesirable dynamic contrast in brightness transformation as well as chrominance transformation since the intensity of each pixel of a frame is lasted for a certain period of time overlapping with the intensity of each pixel of a following frame. Therefore, each frame of the dynamic images has undesirable dynamic color contrast while processing moving images, and consequently the LCS display can't provide good moving image quality.

The slow response time with respect to a bias exerting on a pixel equivalent circuit is considered to be the cause of the LCD display to have poor moving image quality. Referring to FIG. 2A and FIG. 2B, which are schematic views respectively showing a panel circuit of a LCD monitor and a pixel equivalent circuit thereof. As seen in FIG. 2A, the LCD panel circuit 200 is primarily composed of: a pixel array, having a plurality of pixel equivalent circuits 210 arranged therein; a data driver 220; and a scan driver 230; wherein each pixel equivalent circuit 210 is controlled by the scan driver 230 for accepting corresponding voltages of pixel brightness provided by the data driver 220.

In addition, as seen in FIG. 2B, each pixel equivalent circuit is generally composed of a capacitor 215 and a transistor 217. Therefore, the transistor 217 mounted on the coupling path between the capacitor 215 and the data driver 220, i.e. the data line, and controlled by the scan line provided by the scan driver 230, is capable of deciding whether the data line of the capacitor 215 is electrically conducted, that is, whether the capacitor 215 can accepts the voltage supplied from the data driver 220.

It is well known for persons skilled in the art that the charging process and the discharging process of the capacitor 215 are accomplished as a result of a period of time instead of a very short time. Thus, when the scan line turns on the transistor 217 enabling the capacitor 215 to accept the voltage supplied from the data line for performing a charging process, the corresponding intensity profile is shown as the ascending waveform of FIG. 1B. On the other hand, when the scan line turns off the transistor 217 enabling the capacitor 215 performs a discharging process by connecting to ground, the corresponding intensity profile is shown as the descending waveform of FIG. 1B. The charging process and the discharging process of the capacitor 215 is the cause of the hold-type effect of the LCD display.

Consequently, in a condition of long charging/discharging processes applied to the capacitor of the pixel equivalent circuit of the LCD monitor, the brightness transformation performed by the pixel equivalent circuit usually brings no discrimination between different brightness levels, which is not the impulse-type profile as the CRT monitor. Therefore, dynamic brightness contrast between frames of the moving images is undesirable when the LCD monitor processes moving images. In other words, there is formed an image smear phenomenon between different brightness levels of the frames. Based on the same reason, the pixel equivalent circuit also causes the same problem in chrominance transformation.

Moreover, the charging and discharging processes of the capacitor, which is mounted on the pixel equivalent circuit of the LCD monitor, not only cause the frames of the LCD monitor to have undesirable dynamic color contrast, but also cause the problems of edge-blur and stroboscopic motion.

In view of the aforementioned description, the present invention provides a pixel equivalent circuit and a method for improving a hold-type effect. The present invention is capable of enabling the pixels of a LCD monitor to provide better dynamic contrast during the color (brightness and chrominance) transformation thereof. Moreover, the present invention capable of enabling the pixels of a LCD monitor to provide desirable dynamic color contrast for each frame of moving images in a manner similar to that of the CRT monitor.

### SUMMARY OF THE INVENTION

The primary object of the invention is to provide a LCD monitor with a pixel equivalent circuit capable of providing high dynamic color contrast for frames displayed by the LCD monitor. For achieving this object, the present invention provides a pixel equivalent circuit for improving a hold-type effect, comprising: a capacitor, having a first terminal coupled to a node connecting to a first data line and a second data line, and a second terminal coupled to ground; a first electronic switch, mounted on a path between the node and the first data line; and a second electronic switch mounted on a path between the node and the second data line; wherein the first electronic switch control the first data line to be conductive with respect to the a first scan line, and second electronic switch control the second data line to be conductive with respect to the a second scan line.

For achieving the same object described above, the present invention further provides a pixel equivalent circuit for improving a hold-type effect, comprising the capacitor, the first electronic switch, and the second electronic switch, wherein the first terminal of the capacitor is coupled to a node connecting a data line and a voltage source, and the second electronic switch is mounted on the path between the node and the voltage source for controlling the conduction of a voltage of the voltage source to the node with respect to the second scan line.

For achieving the same object described above, the present invention provides a method for improving a hold-type effect, comprising the steps of: providing a capacitor having a plurality of pixel charging paths for a pixel equivalent circuit; and utilizing a plurality of electronic switches to decide whether the corresponding pixel charging paths is electrically conductive.

In the preferred embodiment of the present invention, a capacitor with two pixel charging paths are provided and two electronic switches are utilized to decide whether these two pixel charging paths are electrically conductive.

Therefore, the capacitor of each pixel equivalent circuit comprises a plurality of pixel charging paths that can be used for supplying voltage to a target image, inserting a voltage of a black frame into voltage of the target image, or supplying a voltage of compensating frame into voltage of the target image.

The aforementioned pixel equivalent circuit and method for improving a hold-type effect can be applied to a pixel equivalent circuit with a corresponding liquid crystal having a normal white property or normal black property.

### BRIEF DESCRIPTION OF THE DRAWINGS

FIG. 1A and FIG. 1B shows relationship diagrams between pixel brightness and time of a CRT monitor and a LCD monitor respectively.

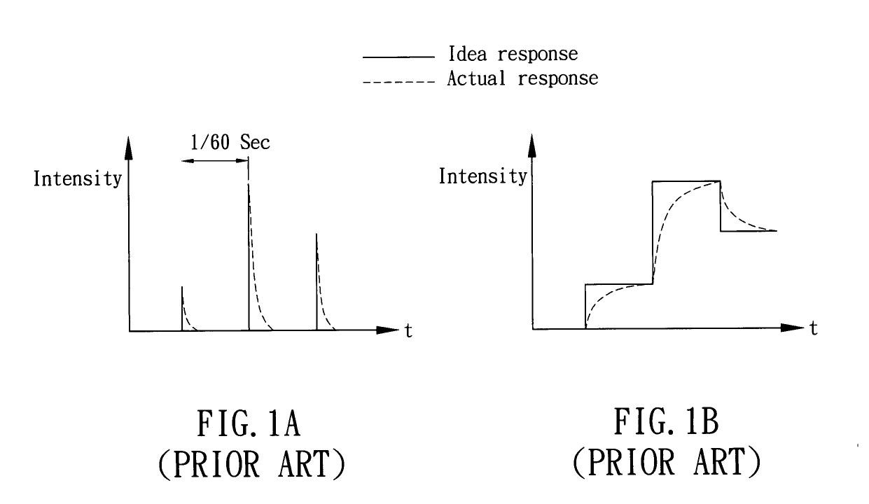

FIG. 2A and FIG. 2B are schematic views showing a panel circuit of a LCD monitor and a pixel equivalent circuit thereof respectively.

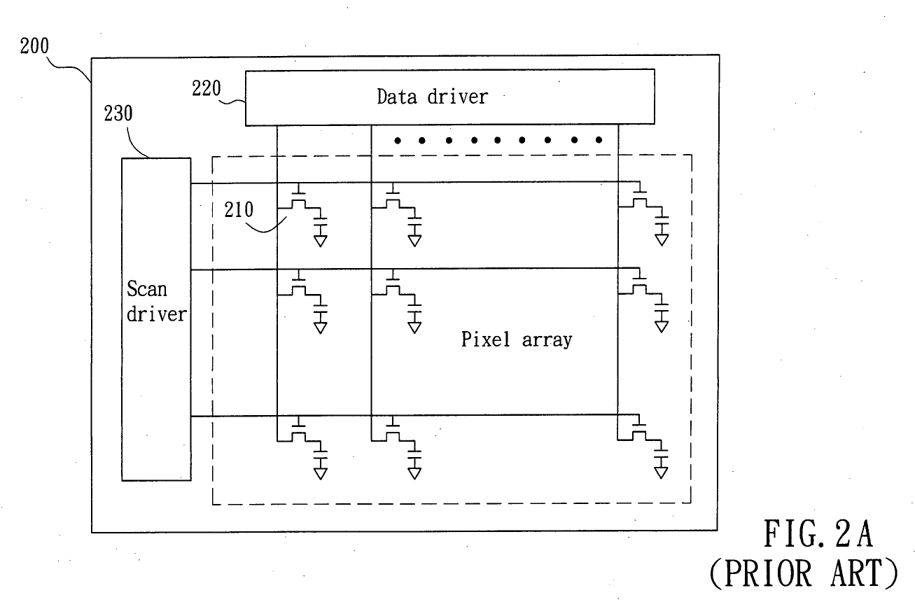

FIG. 3 is a schematic view showing a pixel equivalent circuit in accordance with a preferred embodiment of the present invention.

FIG. 4 is a timing diagram showing the timing of charging voltages received by the capacitor from either the data line A or the data line B with respect to the scan lines A, B.

FIG. 5 is a waveform comparison diagram between a conventional pixel equivalent circuit and the pixel equivalent circuit of the present invention, in both of them the data lines operating in cooperative with the scan lines.

FIG. 6 is a schematic view showing an equivalent circuit of another preferred embodiment of the present invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

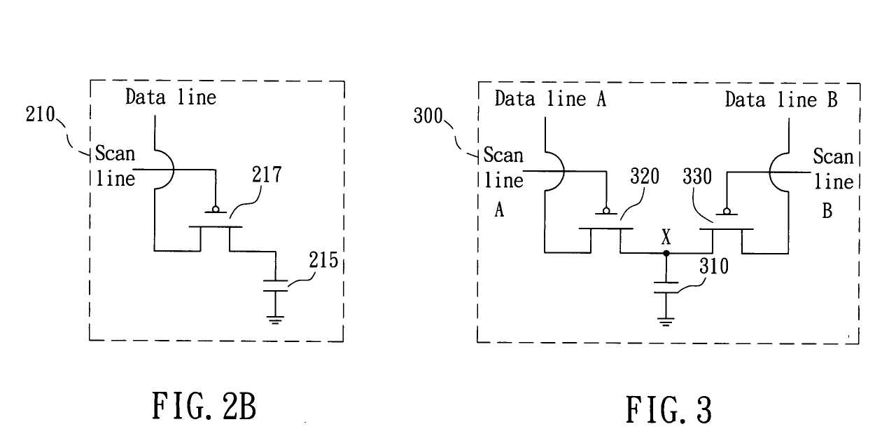

Referring to FIG. 3, which shows a pixel equivalent circuit in accordance with a preferred embodiment of the present invention. This pixel equivalent circuit 300 is composed of a capacitor 310 and two thin-film transistors 320, 330, wherein the source of the thin-film transistor 320 is connected to a data line A, and the drain of the thin-film transistor 320 is connected to a node X connecting to the capacitor 310, and the gate of the thin-film transistor 320 is connected to a scan line A; and the source of the thin-film transistor 330 is connected to a data line B, and the drain of the thin-film transistor 330 is connected to a node X connecting to the capacitor 310, and the gate of the thin-film transistor 330 is connected to a scan line B. The thin-film transistors 320, 330 can be referred as the abovementioned electronic switches, and is used for controlling the capacitor 310 to receive the charging voltage either from data line A or the data line B with respect to the scan line A and the scan line B.

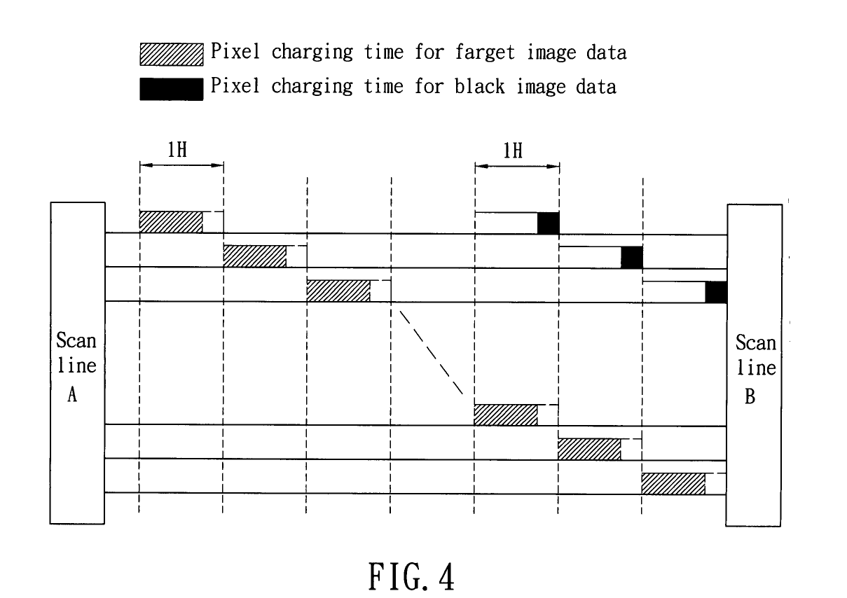

Referring to FIG. 4, which a timing diagram showing the timing of charging voltages received by the capacitor from either the data line A or the data line B with respect to the scan lines A, B. According to the present invention, the scan lines A, B of the pixel equivalent circuit are capable of deciding whether the data lines A, B are electrically conductive so as to enable the data lines A, B to supply various voltage to the corresponding capacitor, such that the intensity profile of the pixel corresponding to the foregoing capacitor is shown as that of an impulse-type CRT monitor.

Consequently, if a duty cycle H of pixel charging time for target image data of prior art is employed in the timing sequence of charging the capacitor of corresponding pixel equivalent circuit while the liquid crystal corresponds to the pixel equivalent circuit has a normal white (NW) property, the scan line A is assigned to supply the voltage of target image during such conventional duty cycle (each is indicated by 1H) for the capacitor, and the scan line B directs the data line B to supply with a voltage of black image, in addition, the timing of supplying the black image voltage corresponds to the timing of supplying the target image voltage. Therefore, a black image voltage can be inserted into the target image voltage during each duty cycle H. That is, within each duty cycle H, the target image voltage is applied in an interval of Ta and no voltage is applied in another interval of Tb, wherein Ta+Tb=H.

Therefore, as the capacitor of pixel equivalent circuit has two pixel charging paths, the charging voltages as shown in FIG. 4 can be provided by the control of the the electronic switches located on two pixel charging paths so as to enable the intensity profile of the pixel corresponding to the foregoing capacitor is shown as that of an impulse-type CRT monitor.

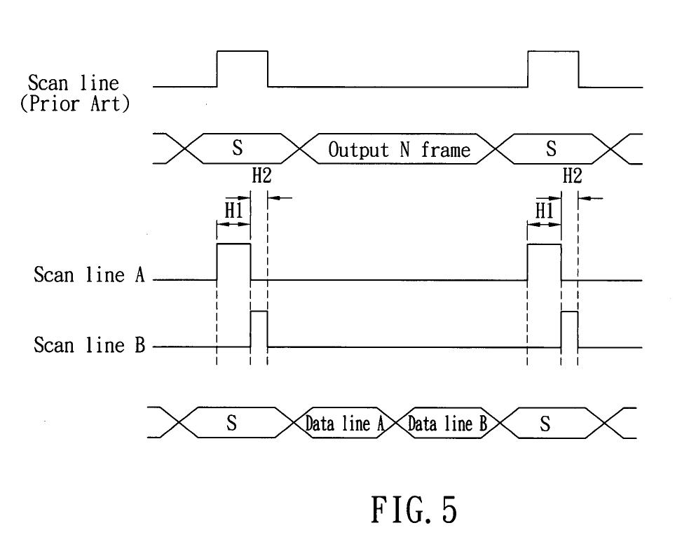

Referring to FIG. 5, which is a diagram showing waveform comparison between a conventional pixel equivalent circuit and the pixel equivalent circuit of the present invention, in both of them the data lines are operating in cooperative with the scan lines. During the duty cycle S, the voltage applied to the scan line of the conventional pixel equivalent circuit takes an ascending waveform, which indicates that the data line corresponding to this scan line is electrically conductive during the duty cycle S. Therefore, the capacitor of the conventional pixel equivalent circuit receives N frame voltages supplied from this data line after the duty cycle S.

During the duty cycle S, voltages applied to the scan lines A, B of the pixel equivalent circuit of the present invention take an ascending waveform in sequence, wherein during the duty cycle S, an ascending waveform is applied to the scan line A in the interval of H1 and another ascending waveform is applied to the scan line B in the interval of H2. In other words, the data lines A, B that correspond to the scan lines A, B are electrically conductive during the duty cycle S. Moreover, the capacitor of the pixel equivalent circuit of the present invention receives a charging voltage supplied from the scan line A, and thereafter receives another charging voltage supplied from the scan line B after the duty cycle S.

Consequently, for the conventional pixel equivalent circuit, the capacitor merely monotonously receives the charging voltage supplied from the data line. However, two scan lines of the pixel equivalent circuit of the present invention are capable of respectively deciding whether these two data lines are electrically conductive, and the capacitor thereof is able to receive both the target image voltage and the black image voltage, for example. Thus, the pixel color curve, which is shown by the pixel of the pixel equivalent circuit of the present invention, is similar to that of the CRT monitor. Moreover, the capacitor is capable of receiving such as a compensating voltage as a compensation for the target image voltage for compensating the process of moving images of the pixel equivalent circuit or the process of speeding up data renewal by the pixel equivalent circuit.

It is noted that the pixel equivalent circuit of the present invention is carried out by adopting data drivers as sources of voltages of pixel charging paths. Alternatively, a single voltage source can be adopted as a source of voltages of d pixel charging paths.

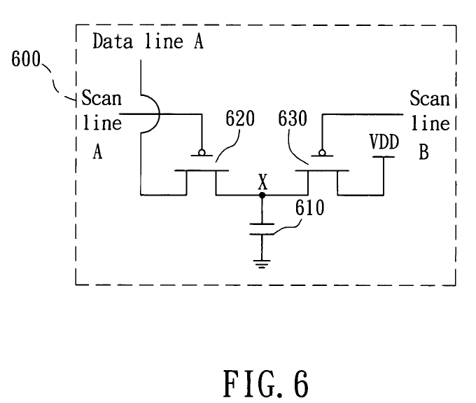

Referring to FIG. 6, which is a schematic view showing a pixel equivalent circuit of another preferred embodiment of the present invention. As shown in FIG. 6, an pixel equivalent circuit 600 still utilizes thin-film transistors 620, 630 to decide whether two data write paths are electrically conductive, wherein these two pixel charging paths are modified to be composed of coupling paths of data line A, a voltage source VDD, and a capacitor 610. Especially, the data line A of one pixel charging path couples with a data driving device (not shown) for supplying a target image voltage for the capacitor 610 via the data line A. However, the other pixel charging path utilizes a voltage source VDD to supply such as a black image voltage for the capacitor 610.

As described above, the present invention provides a pixel equivalent circuit and a method for improving a hold-type effect. By providing a capacitor of a pixel equivalent circuit with plural pixel charging paths and supplying a target image voltage and such as a black image voltage or a compensating voltage for the capacitor during a corresponding duty cycle, a color curve, which is shown by a corresponding pixel of the pixel equivalent circuit of the present invention, is similar to that of the CRT monitor or the speed of renewing data of the target image voltage is raised such that the pixel equivalent circuit of the present invention is capable of improving the color-renewing speed and image quality when it processes the moving image.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What is claimed is:

1. A pixel equivalent circuit for improving a hold-type effect, comprising:
a capacitor, having a first terminal and a second terminal, said first terminal being coupled to a node connecting to a first data line and a second data line, said second terminal being coupled to ground;
a first electronic switch, mounted on a path between said node and said first data line, capable of controlling the electrical conducting of said first data line with respect to a first scan line; and
a second electronic switch, mounted on another path between said node and said second data line, capable of controlling the electrical conducting of said second data line wit respect to a second scan line.

2. The pixel equivalent circuit of claim 1, wherein said first electronic switch is a transistor having a first terminal coupled to said first data line, a second terminal coupled to said first scan line, and a third terminal coupled to said node.

3. The pixel equivalent circuit of claim 2, wherein said first terminal is the source of said transistor, and said third terminal is the drain of said thin-film transistor, and said second terminal is the gate of said thin-film transistor.

4. The pixel equivalent circuit of claim 1, wherein said second electronic switch is a transistor having a first terminal coupled to said second data line, a second terminal coupled to said second scan line, and a third terminal coupled to said node.

5. The pixel equivalent circuit f of claim 4, wherein said first terminal is the source of said transistor, and said third terminal is the drain of said thin-film transistor, and said second terminal is the gate of said thin-film transistor.

6. A pixel equivalent circuit for improving a hold-type effect, comprising:
a capacitor, having a first terminal and a second terminal, said first terminal of said capacitor being coupled to a node connecting to a data line and a voltage source, said second terminal being coupled to ground;
a first electronic switch, mounted on a path between said node and said data line, capable of controlling the electrical conducting of said first data line with respect to a first scan line; and
a second electronic switch, mounted on another path between said node and said data line, capable of controlling the electrical conducting of said second data line wit respect to a second scan line.

7. The pixel equivalent circuit of claim 6, wherein the voltage of the voltage source is a voltage of black image while a liquid crystal corresponding to said pixel equivalent circuit has a normal white (NW) property.

8. The pixel equivalent circuit of claim 6, wherein the voltage of the voltage source is a ground voltage while a liquid crystal corresponding to said pixel equivalent circuit has a normal black property.

9. The pixel equivalent circuit of claim 6, wherein said first electronic switch is a transistor having a first terminal coupled to said data line, a second terminal coupled to said first scan line, and a third terminal coupled to said node.

10. The pixel equivalent circuit of claim 9, wherein said first terminal is the source of said transistor, and said third terminal is the drain of said thin-film transistor, and said second terminal is the gate of said thin-film transistor.

11. The pixel equivalent circuit of claim 6, wherein aid second electronic switch is a transistor having a first terminal coupled to said voltage source, a second terminal coupled to said second scan line, and a third terminal coupled to said node.

12. The pixel equivalent circuit of claim 11, wherein said first terminal is the source of said transistor, and said third terminal is the drain of said thin-film transistor, and said second terminal is the gate of said thin-film transistor.

13. A method for improving a hold-type effect, comprising the steps of:
providing a capacitor having a plurality of pixel charging paths in a pixel equivalent circuit; and
utilizing a plurality of electronic switches to control the electrical conducting of the corresponding pixel charging path.

14. The method of claim 13, wherein the pixel equivalent circuit comprises two pixel charging paths and two electronic switches.

15. The method of claim 13, wherein said plurality of electronic switches decide whether said plurality of pixel charging paths are electrically conductive according to the corresponding scan line.

16. The method f of claim 13, further comprising the steps of:
providing a voltage of target image with at least a duty cycle to at least a path out of sail plural pixel charging paths while the liquid crystal corresponding to said pixel equivalent circuit has a normal white property; and
providing a voltage of black image to another path of said plural pixel charging paths with correspondence to said duty cycle for inserted said voltage of black image into said voltage target image within said duty cycle.

17. The method of claim 13, further comprising the step of:
charging a voltage of target image to said capacitor simultaneously by way of said plural pixel charging paths while said capacitor is being charged.

18. The method of claim 13, further comprising the steps of:
charging a voltage of target image to said capacitor by a path selected out of said plural pixel charging paths while said capacitor is being charged; and
providing a voltage of compensating image to said capacitor by another path selected out of said plural pixel charging paths for compensating said voltage of target image with respect to the duty cycle of said voltage of target image.
